(19) United States
(12) Patent Application Publication
(10) Pub. No.: US 2015/0193822 A1
(43) Pub. Date: Jul. 9, 2015

(54) APPARATUS AND METHOD FOR INFERRING USER PROFILE

(71) Applicant: Electronics and Telecommunications Research Institute, Daejeon-si (KR)

(72) Inventors: Kyeong-Soo HAN, Daejeon-si (KR); Han-Kyu LEE, Daejeon-si (KR)

(73) Assignee: Electronics and Telecommunications Research Institute, Daejeon-si (KR)

(21) Appl. No.: 14/591,986

(22) Filed: Jan. 8, 2015

(30) Foreign Application Priority Data
Jan. 8, 2014 (KR) 10-2014-0002592

(51) Int. Cl. G06Q 30/02

(52) U.S. Cl. CPC G06Q 30/0255; G06Q 30/0201

(57) ABSTRACT

An apparatus for inferring a user profile includes a data processor configured to analyze viewing patterns of sample families from received sample family data, extract viewing pattern characteristics from the analyzed viewing patterns, and generate one or more sorters by classifying the viewing pattern characteristics into groups; a target family data processor configured to generate target family viewing pattern information based on received target family data; and a profile inference component configured to generate a primary inference result by classifying the target family viewing pattern information through the one or more sorters, and inferring a specific group of members present in the target family based on the viewing pattern characteristics.

### CROSS-REFERENCE TO RELATED APPLICATION(S)

This application claims priority from Korean Patent Application No. 10-2014-0002592, filed on Jan. 8, 2014, in the Korean Intellectual Property Office, the disclosure of which is incorporated herein by reference in its entirety.

### BACKGROUND

1. Field

The following description relates to broadcasting services, and more particularly, to technology for analyzing viewership history for broadcasting services.

2. Description of the Related Art

With the recent switchover to digital broadcasting, growing attention has been given to customized advertising (i.e. targeted advertising), which differs from conventional advertising services that simply expose the advertisements to viewers. For a Video-on-Demand (VoD) service on an IPTV, advertisements are inserted at the beginning and/or the end of the video. Recently, many attempts have been made to customize such advertisements to individual audiences. With the development of technology for not only IPTVs, but also smart TVs, such as hybrid TV that combines the Internet and terrestrial broadcast content, Internet connectivity of such TVs made it possible to depart from the traditional unidirectional broadcast services and unilateral terrestrial broadcast content services and provide viewers with bidirectional, interactive services. With the growing popularity of the bidirectional, interactive broadcast services, techniques for customizing advertising services are also being developed.

Generally, an advertiser provides demographical profiles of target consumers, such as the age range and gender of the target, as the requirement of the advertisement. The broadcast media or broadcast advertising agencies, however, have no information about the demographical profiles of individual audiences as the target consumers of the advertisement, and they thus schedule and execute the advertisement for a broadcast program popular to viewers of target gender/age groups, based on data, such as audience rating statistics, and experiences and history of executing advertisements. However, the audience rating statistics for broadcast content or the advertising execution history are merely statistical data, and do not reflect the preferences or needs of individual audiences. Hence, it is not possible to provide effective targeted advertising to each individual viewer, based on such data. Meanwhile, even without the knowledge of a current audience, if the gender/age ranges of members of a family are known, a family-targeted advertising, which is customized to the family members, is possible. Generally, a service provider, however, has only access to a profile of a representative subscriber, and no access to profiles of individual family members. Further, for the sake of privacy protection, the representative subscriber information cannot be utilized for any purpose, other than for subscription to services.

Korean published patent application No. 10-2008-0106799 discloses a method of providing content to audiences by collecting and processing viewing behaviors of the audiences. In this patent application, a system includes all unique information of individual members of a family, and viewership histories are collected and viewing behaviors are analyzed after authenticating each member through a login. Thus, for a family whose member profiles of each member are not known, it is not possible to collect viewership histories or analyze viewing behaviors.

### SUMMARY

The following description relates to an apparatus and method for inferring a user profile for analyzing viewership history so that preference or needs of each individual user can be reflected to in targeted advertising.

In one general aspect, there is provided an apparatus for a user profile, including: a data processor configured to analyze viewing patterns of sample families from received sample family data, extract viewing pattern characteristics from the analyzed viewing patterns, and generate one or more sorters by classifying the viewing pattern characteristics into groups; a target family data processor configured to generate target family viewing pattern information based on received target family data; and a profile inference component configured to generate a primary inference result by classifying the target family viewing pattern information through the one or more sorters and inferring a specific group of members present in the target family based on the viewing pattern characteristics.

The sample family data processor may be configured to calculate one or more probabilities related to TV viewing by analyzing viewership history contained in the received sample family data, and the profile inference component may be configured to calculate viewership probability distributions of individual groups of viewers from the one or more calculated probabilities related to TV viewing, and, in response to receiving a request for TV viewing from a viewer that is a member of the target family, generate a secondary inference result by calculating conditional probabilities for individual groups of viewers from a probability distribution of viewing TV in a specific time interval on a specific day of week corresponding to the received request and a probability distribution of viewing a specific type of program corresponding to the received request. The profile inference component may be configured to infer, based on a likelihood of presence of family member according to the primary inference result and viewership probability distributions according to the secondary inference result, that a group with a largest conditional probability value is an audience member group of the target family.

The profile inference component may be configured to, in a case where family member profiles of the target family are known, infer, based on a likelihood of presence of the family member profiles of the target family and the viewership probability distributions according to the secondary inference result, that a group of viewers with a largest conditional probability value is an audience member group of the target family.

The sample family data processor may be configured to calculate at least one of viewership probabilities according to an amount of TV viewing by type of program, an amount of TV viewing by time of day or an amount of TV viewing by time of day and type of program, a viewership distribution by type of program, a viewership distribution by time of day, or a viewership distribution by time of day and type of program.

The sample family data processor may be configured to generate the one or more sorters by classifying the viewing pattern characteristics into groups according to at least one of gender of viewers, age range of viewers, or type of program. In addition, the sample family data processor may be configured to analyze the sample family data that contains the viewership history and profiles of sample families. The target family data processor may be configured to generate the target family viewing pattern information from target family data that only contains viewership history of the target family. The profile inference component may be configured to generate the primary inference result by inferring a specific group of viewers present in the target family by classifying the target family viewing pattern information using sorters that correspond to viewing patterns that are not duplicated among the viewing patterns, which have been classified into the groups for generating the sorters.

In another genera aspect, there is provided a method of inferring a user profile, including: analyzing viewing patterns of sample families from received sample family data;

extracting viewing pattern characteristics from the analyzed viewing patterns and generating one or more sorters by classifying the viewing pattern characteristics into groups;

generating target family viewing pattern information from received target family data; and generating a primary inference result by classifying the target family viewing pattern information through the sorters and inferring a specific group of members present in the target family. In addition, the method may further include inferring, based on a likelihood of presence of family member according to the primary inference result and viewership probability distributions according to the secondary inference result, that a group of viewers with a largest conditional probability value is an audience member group of the target family. In a case where family member profiles of the target family are known, the method may further include inferring, based on a likelihood of presence of the family member profiles of the target family and the viewership probability distributions according to the secondary inference result, that a group of viewers with a largest conditional probability value is an audience member group of the target family.

Other features and aspects will be apparent from the following detailed description, the drawings, and the claims.

### BRIEF DESCRIPTION OF THE DRAWINGS

FIG. 1 is a diagram illustrating an example of an apparatus for inferring user profile.

FIG. 2 is a diagram illustrating an inference engine for a primary inference of the profile inference component according to an exemplary embodiment.

FIGS. 3A to 3C are graphs to explain the primary inference process of an apparatus for inferring a user profile according to an exemplary embodiment.

FIG. 4 is a diagram to show procedures of a secondary inference process of an apparatus for inferring a user profile according to an exemplary embodiment.

FIGS. 5A to 5F are diagram to explain process of inferring individual audiences by a user inference apparatus according to the exemplary embodiment.

FIG. 6 is a flowchart illustrating a method of inferring a user profile according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

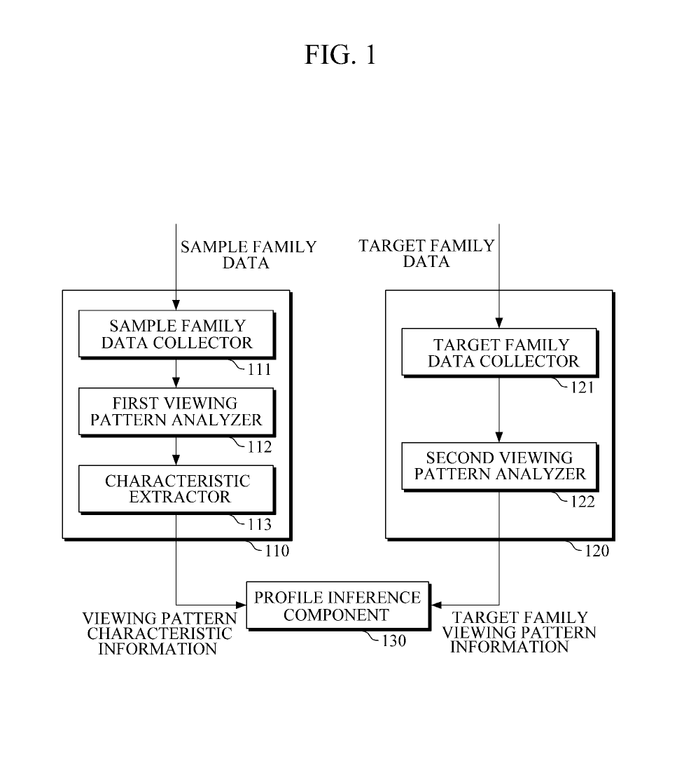

FIG. 1 is a diagram illustrating an example of an apparatus for inferring user profile.

Referring to FIG. 1, the apparatus 100 includes a sample family data processor 110, a target family data processor 120, and a profile inference component 130.

The sample family data processor 110 collects sample family data. The sample family data contains viewership history and profiles of sample families. The sample families who are audiences whose compositions and member profiles that include the age range and gender of each member are known are generally registered in advance for the audience rating measurement. The sample family data processor 110 may collect sample family data including viewership history and profiles of individual family members. The sample family data may distinguish each family by a family ID, and distinguish each viewer in each family by an individual ID. Thus, it is possible to classify the viewership history of the sample families by families in general, and also by individual family members.

In addition, the sample family data processor 110 analyzes viewing patterns and viewership history of each sample family based on the received sample family data. The received sample family data includes information about viewership history that corresponds to the profile of the entire family of each sample family and the profiles of their individual family members. The analysis method of the sample family data processor 110 to analyze the viewership history is not limited to the aforementioned method, and various viewing-history analysis methods may be applicable according to the environment or types of broadcast services.

The viewership history of each sample family are identified according to individual audiences, thereby making it possible to analyze viewing patterns according to gender, age range, and group of viewers. On the other hand, gender and age distributions of family members of the target family are unknown and viewership history of audiences in the target family are all mixed together. Therefore, viewing patterns cannot be analyzed with respect to an individual audience member, but can only be analyzed with respect to the target family as a whole. In other words, the age range and gender of each member of the sample families can be identified based on the individual family member profiles, whereas the target family is provided with no specific profile of each member, and thus it is not possible to identify the age range and gender of each member of the target family. Further, in the viewership history of the target family, the family members' viewership history is all mixed together. Because the apparatus 100 in accordance with the exemplary embodiment infers age range and gender distribution of audiences by comparing the sample family data and the target family data, the sample family data processor 110 needs to analyze the viewing patterns not based on each audience member but based on each family.

The sample family data processor 110 extracts viewing pattern characteristics of audiences of each age range and gender group from the viewing patterns of each family amongst the sample families. In general, audiences of the same age range and gender are more likely to exhibit similar viewing patterns. The viewing pattern characteristics of audiences of a specific gender/age range group are extracted by comparing the viewing patterns of families that include the corresponding audiences of the specific gender/age range with the viewing patterns of families that do not include the pertinent audiences. To this end, the sample family data processor 110 categorizes the viewing patterns of the sample families by age range and gender and divides the sample families into two groups: one group of families that include members of the specific gender and age range; and the other group of families that do not include members of the specific gender and age range. For example, if the total of 200 sample families consist of 50 families, each including at least one man in his 20s, and the other 150 families that do not include any men in their 20s, a group of male viewers aged 20 to 29 is divided by 50 to 150, and if the 200 sample families consist of 30 families, each including at least one woman in her 20s, and the rest of 170 families, a group of female viewers aged 20 to 29 is divided by 30 to 170. As such, with respect to N specific age range and gender groups of viewers intended to be sorted, the sample family data processor 110 generates 2N data groups, including N groups of viewer families including the corresponding specific age range and gender groups and N groups of the other viewer families that include none of the corresponding specific age range and gender groups. In addition, the sample family data processor 110 extracts the viewing pattern characteristics of each data group from the viewing patterns of the 2N data groups divided by gender and age. Sorter studying is carried out with respect to viewer families that include “men in their 20s” and the other viewer families that include no “men in their 20s,” so that a sorter for determining the presence of men in their 20s in a target family can be created. Individual sorters are also generated for the other viewers of different gender/age ranges. As many sorters are generated as the number N of the gender/age range groups of viewers to be sorted. The sorter studying algorithm of the sample family data processor 110 may vary according to the purpose and use, without being limited to a specific sorter studying algorithm.

The sample family data processor 110 delivers to the profile inference component 130 the viewing pattern characteristics information of the sample families, which include the sorters that have been generated by analyzing the viewing patterns in a primary inference process.

Then, for a secondary inference process, the sample family data processor 110 may analyze the amount of each type of programs being watched, the amount of TV viewing by time of day, the amount of TV viewing by type of program and by time of day, the distribution of TV viewing by type of program, the distribution of TV viewing by time of day, and the distribution of TV viewing by type of program and by time of day. The sample family data processor 110 may analyze viewership history of the sample families whose member profiles, including the gender/age range of each member, are known, and calculate the viewership probability by time and day for each gender/age range group of viewers, and the viewership probability of a type of program for each age range and gender group of viewers. The calculated viewership probabilities are re-calculated into viewership probability distribution of individual groups. For example, the viewership probabilities by type of program and by time of day and day of week may be represented as conditional probabilities of the probability distribution of TV viewing by time of day and day of week and the probability distribution of TV viewing by type of program. The sample family data processor 110 delivers the generated probability distribution data to the profile inference component 130.

The target family data processor 120 gathers (receives) target family data from a target family for inferring the distribution of genders and age ranges of viewers. The age range/gender profile of each family member included in the sample family data allows for identification of individual family members' age range and gender, whereas the number of family members and the age range and gender of each family member of the target family are not known. In addition, the viewership history of each member within a target family is combined together, so that it is not possible to analyze the viewing patterns of each viewer. Therefore, the target family data processor 120 analyzes the viewing patterns of each audience target family in general based on the viewership history. The target family data processor 120 delivers, to the profile inference component 130, target family viewing pattern information generated by analyzing the viewership history.

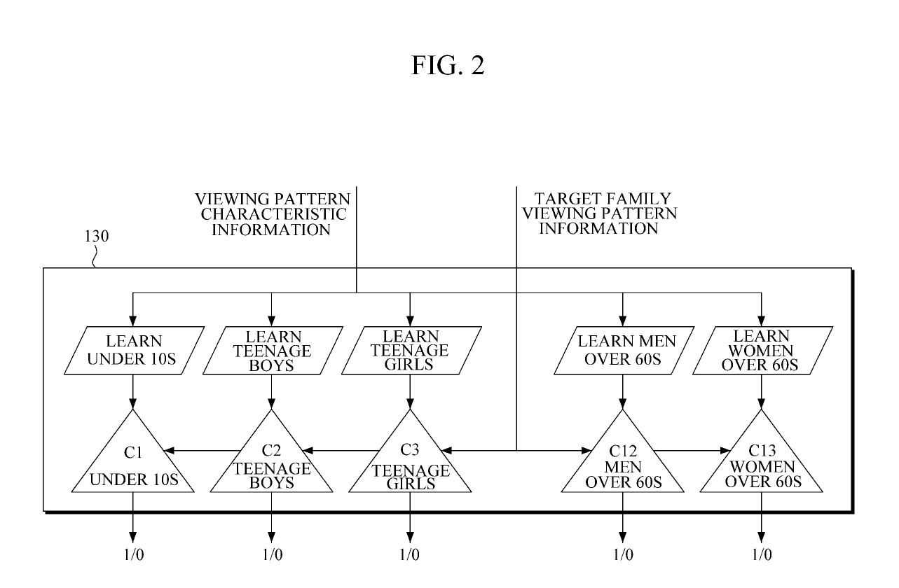

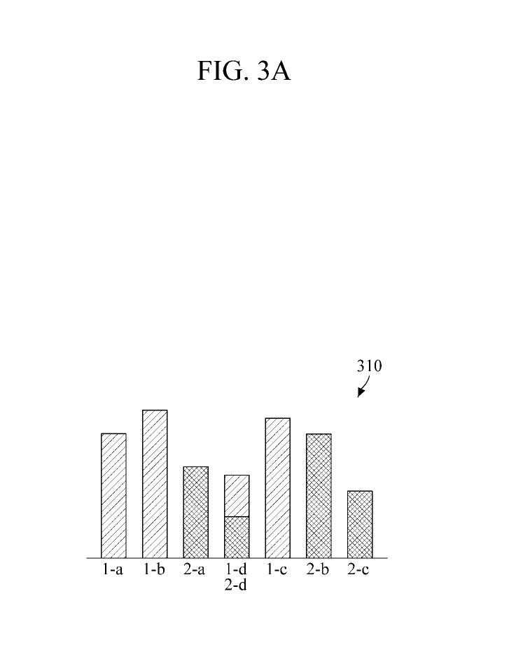

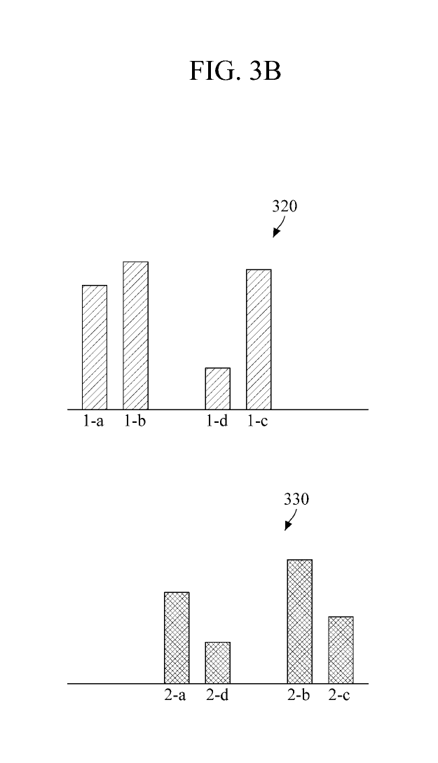

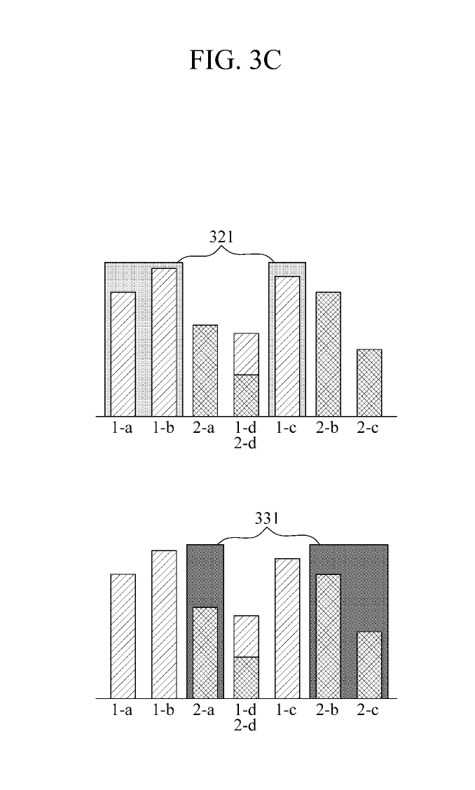

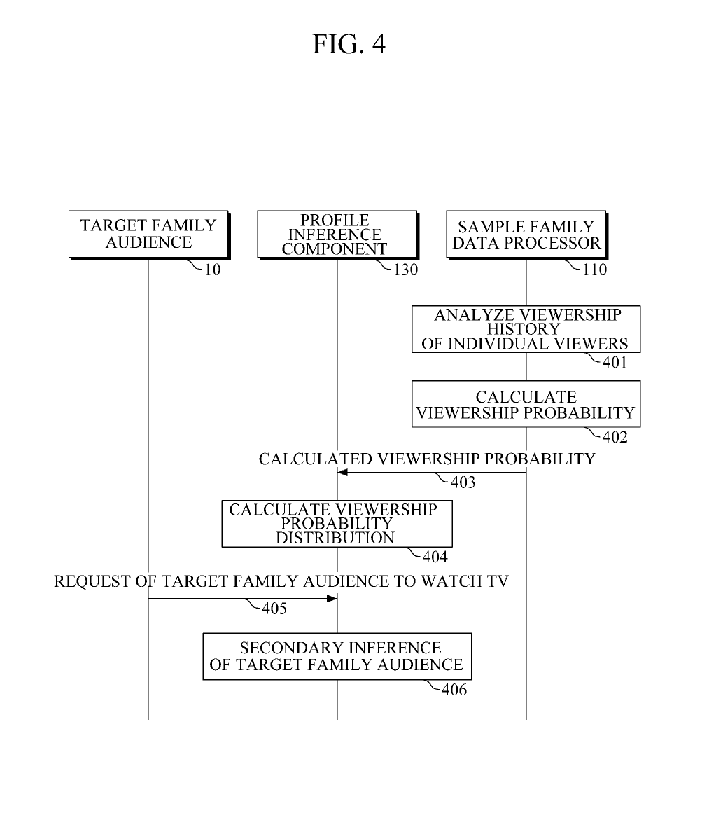

The profile inference component 130 infers a profile of the target family based on the sample families' viewing pattern characteristics information received from the sample family data processor 110 and the target family viewing pattern information received from the target family data processor 120. The procedures of the profile inference component 130 to infer the profile of the target family based on the received sample family viewing pattern characteristics information and target family viewing pattern information will be described with reference to FIG. 2, FIG. 3A, FIG. 3B, FIG. 3C, and FIG. 4.

FIG. 2 is a diagram illustrating an inference engine for a primary inference of the profile inference component according to an exemplary embodiment.

Referring to FIG. 2, the inference engine of the profile inference component 130 of the apparatus 100 for the primary inference in accordance with the exemplary embodiment infers viewers amongst the target family from the target family's viewing pattern information which has been generated by the target family data processor 120 based on the viewing pattern characteristics information generated by the sample family data processor 110. For example, in a case where the sample families' viewing pattern characteristics information contains the viewing pattern characteristics information of 200 sample families, which consist of 50 families including men in their 20s and the other 150 families, a group of male viewers in their 20s is divided by 50 to 150. In a case where the 200 sample families consist of 30 families that include women in their 20s and the rest 170 families, a group of female viewers in their 20s is divided by 30 to 170. As such, with respect to N specific age range and gender groups of viewers intended to be sorted, the sample family data processor 110 generates 2N data groups, including groups of viewer families including the corresponding specific age range and gender groups and groups of the other viewer families that do not include the corresponding specific age range and gender groups. Sorter studying is carried out with respect to the viewing patterns of viewer families that include including men in their 20s, and the viewing patterns of the other families, so that a sorter for determining whether the men in their 20s are present in each viewer family. Similarly, individual sorters are generated for the other age range and gender groups of viewers. As many sorters as the number (i.e. N) of specific age range and gender groups of viewers intended to be sorted are generated.

The profile inference component 130 infers the presence of viewers by classifying the target family's viewing pattern information by use of the sample families' viewing pattern characteristics information which is classified by gender and age. The inference process of the profile inference component 130 may include the primary inference process and the secondary preference process. The primary inference process compares and analyzes the sample family data and the target family data to determine whether the target family includes a member who belongs to a specific group. Then, the secondary inference process infers the presence of a specific viewer based on the result of the first inference, the viewership probability of each group of viewers of sample families and target family and the viewership probability of a type of programs for each group of viewers of sample families and target family.

The result that is obtained during the primary inference of the profile inference component 130 by using the viewing pattern characteristics information as sorters indicates whether characteristic viewing patterns of viewers of specific age range and gender are present. That is, the process of classifying the target family's viewing pattern information using the sample families' viewing pattern characteristics information is similar to the principle of filtering. Two or more viewers' viewership history may be mixed in the target family's viewership history. It is determined whether there are characteristic viewing patterns by classifying the target family's viewership history information based on the sample families' viewership history characteristics, and then it is further determined whether there are viewers with the characteristic viewing patterns. When inferring such profiles as gender and age of the members of each target family based on the target family's viewership history, the apparatus 100 in accordance with the exemplary embodiment identifies viewing patterns of each target family by parallel comparison using the gender/age sorters (sample families' viewing pattern characteristics information). That is, the profile inference component 130 classifies the target family's viewership history information based on the sample families' viewership history characteristics information, and analyzes gender/age-specific characteristics of the viewership history contained in the sample families' viewership history characteristics information, thereby enabling to infer the gender/age groups of members of the target family. The secondary inference process of the profile inference component 130 will be described below with reference to FIG. 4.

FIGS. 3A to 3C are graphs to explain the primary inference process of an apparatus for inferring a user profile according to an exemplary embodiment.

FIG. 3A is a graph illustrating a target family's viewing pattern of the apparatus 100.

FIG. 3A illustrates an exemplary embodiment of viewing patterns 310 of a target family consisting of two members: one belonging to a first group and the other belonging to a second group. FIG. 3A illustrates separately the first group and the second group for convenience of illustration, but, actually, the viewership history has been analyzed for each family without being classified by individual family members, thus making it impossible to identify the number of viewers associated with the viewership history and to recognize the individual viewers of the viewership history at this point. Since the viewership history of the target family is combined with viewing patterns of various viewers, there may be more differences than similarities between the target family's viewing patterns and the viewing patterns according to the sample families' viewership history characteristics information when they are directly compared to each other, and hence, the direct comparison may be highly likely to lead to a wrong conclusion.

FIG. 3B is a graph illustrating examples of viewing patterns 320 of the first-group viewer and viewing patterns 330 of the second-group viewer in accordance with sample families' viewership history characteristics information. The sample family data processor 110 may set sorters by dividing the viewership history of the sample families into two or more groups by gender and age based on the sample families' viewership history characteristics information. In the examples of FIG. 3B, the sorters are set to the viewing patterns 320 of the first-group viewer and the viewing patterns 330 of the second-group viewer. For example, the sorters may be set by dividing the viewing patterns 320 of the first-group viewer and the viewing patterns 330 of the second-group viewer into groups of boys in their 10s, girls in their 10s, men in their 20s, women in their 20, and the like. The viewing patterns 320 of the first-group viewer include viewing patterns 1-a, 1-b, 1-d, and 1-c, and the viewing pattern 330 of the second-group viewer include viewing patterns 2-a, 2-d, 2-b, and 2-c.

The profile inference component 130 classifies the viewing patterns 310 of the target family based on the sorters 320 and 330 set by gender and age by the sample family information processor 110. More specifically, the profile inference component 130 compares the viewing patterns 310 of the target family with the viewing patterns 320 of the first-group viewer to determine similarities, and compares the viewing patterns 310 with the viewing patterns 330 of the second-group viewer to determine similarities. It may be determined whether there are patterns of a viewer of a specific group in the viewing patterns 310 of the target family, which are combined with viewing patterns of various viewers, by comparing the viewing patterns 310 of the target family with each of the viewing patterns 320 of the first-group viewer and the viewing patterns 330 of the second-group. When comparing the viewing patterns 320 of the first-group viewer and the viewing patterns 330 of the second-group viewer with the viewing patterns 310 of the target family, the profile inference component 130 may compare all viewing patterns or compares only the characteristic viewing patterns among the all included patterns. Viewing pattern 1-d among the viewing patterns 320 of the first-group viewer and viewing pattern 2-d among the viewing patterns 330 of the second-group viewer overlap with viewing patterns of a different group. The viewing patterns overlapping with the different group's viewing patterns do not exhibit characteristic values since many values associated with viewers of various groups are combined therein. Thus, only the viewing patterns except viewing patterns 1-d and 2-d are compared with the viewing patterns 310 of the target family. FIG. 3C is a graph to explain a method of inferring the presence of a viewer of a specific group through a comparison between the viewing patterns 310 of the target family with each of the viewing patterns 320 of the first-group viewer and the viewing patterns 330 of the second-group viewer. The profile inference component 130 infers the presence of a viewer 321 that belongs to the first group by comparing the viewing patterns 310 of the target family with viewing patterns 1-a, 1-b, and 1-c out of the viewing patterns 320 of the first-group viewer, excepting the overlapping viewing pattern 1-d. Also, the profile inference component 130 infers the presence of a viewer 331 that belongs to the second group by comparing the viewing patterns 310 of the target family with viewing patterns 2-a, 2-b, and 2-c out of the viewing patterns 330 of the second-group viewer, excepting the overlapping viewing pattern 2-d.

Viewing behaviors of viewers are analyzed from a target viewer family (a target family) whose member profile is unknown, and the analysis result is input to N sorters which are based on the sample families' viewership history characteristics information, so that it is determined whether characteristic viewing patterns of each group are included in the viewing patterns of the target family. The profile inference component 130 infers that a viewer who corresponds to a sorter, which is determined as including the characteristic viewing pattern, belongs to the target family. FIG. 4 is a diagram to show procedures of the secondary inference process of an apparatus for inferring a user profile according to an exemplary embodiment.

Referring to FIG. 4, in the secondary inference process, the sample family data processor 110 analyzes viewership history of the sample families whose member profiles including the age range and gender of each member are known are analyzed in 401, and the probability of viewing is calculated in 402. The viewership history of the sample families contained in the sample family data includes information about the age range and gender of each member of each sample family. Accordingly, the sample family data processor 110 is able to calculate the viewership probability of a type of program for each age range and gender group and the viewership probability by time and day for each age range and gender group using the analysis result of the viewership history of the sample families. Then, in 403, the sample data processor 110 delivers the calculated probabilities to the profile inference component 130.

The profile inference component 130 which has received the calculated probabilities from the sample family data processor 110 re-calculates the received probabilities as the probability distributions for individual groups in 404. For example, the viewership probabilities by type of program, and time and day may be represented as conditional probabilities of the viewership probability distribution by time and day and the viewership probability distribution by type of program. Then, in response to receiving, in 405, a request for viewing a specific type of program in a specific time interval on a specific day of week from a viewer 10 of a target family, the profile inference component 130 calculates conditional probabilities for each age range and gender group of viewers from the viewership probability distribution of each group of viewers in the specific time interval on the specific day of week and the viewership probability distributions of the specific type of program for each group of viewers and obtains the viewership probability distribution of the corresponding group of viewers watching the specific type of program in the specific time interval of the specific day, which results from the secondary inference in 406. The obtained viewership probability distribution as the outcome of the secondary inference is represented as the viewership probability distribution of the different age range and gender groups of viewers.

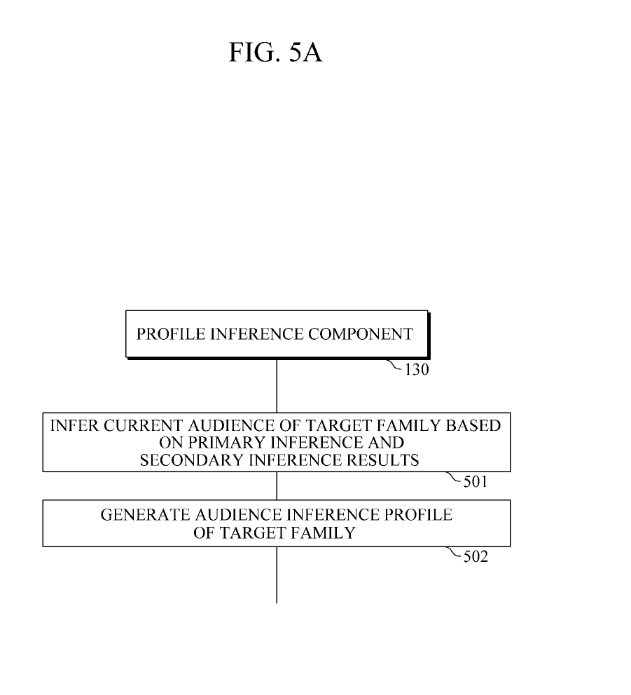

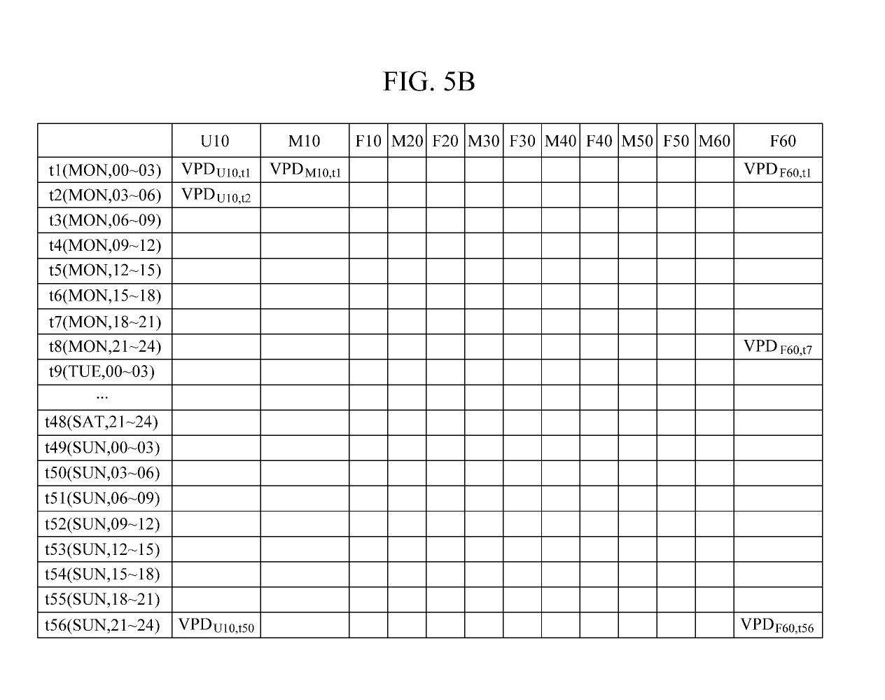

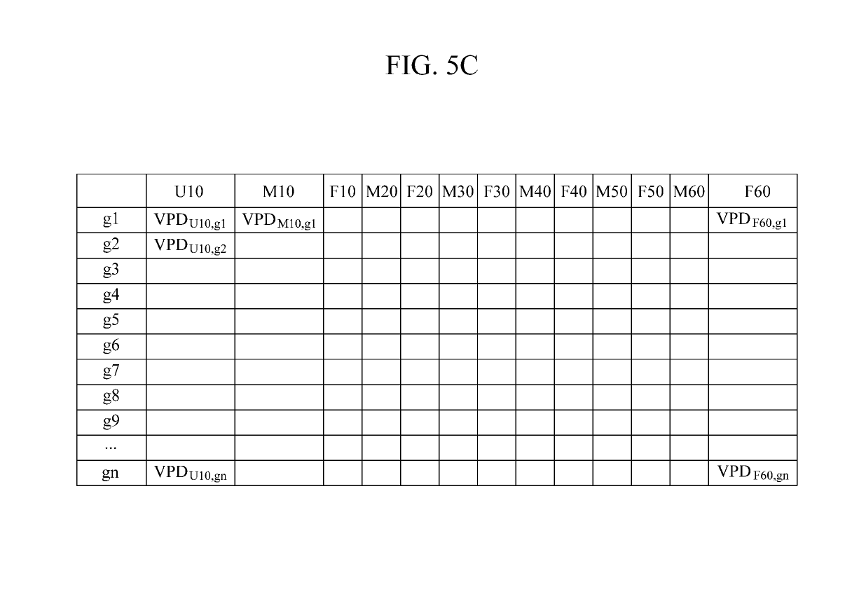

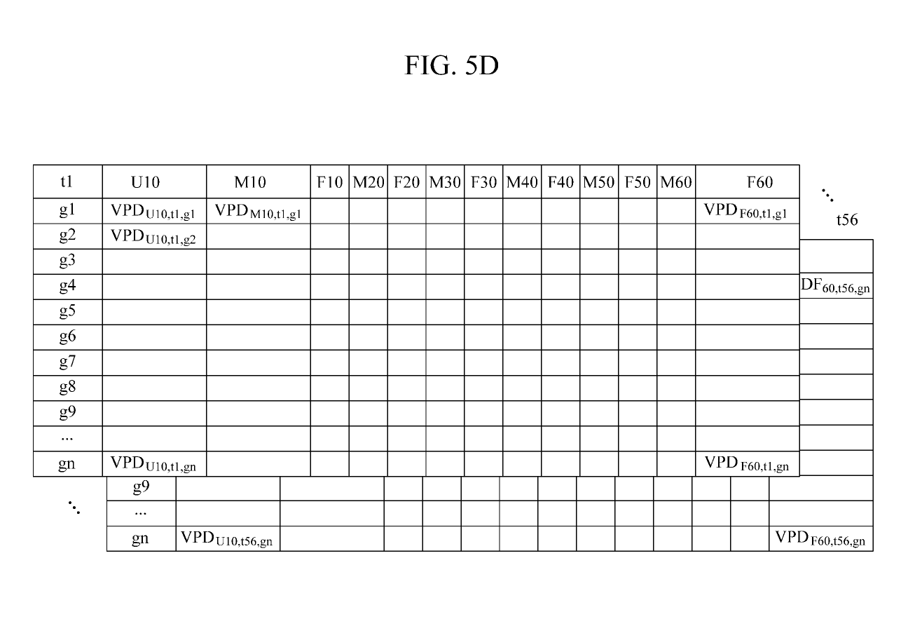

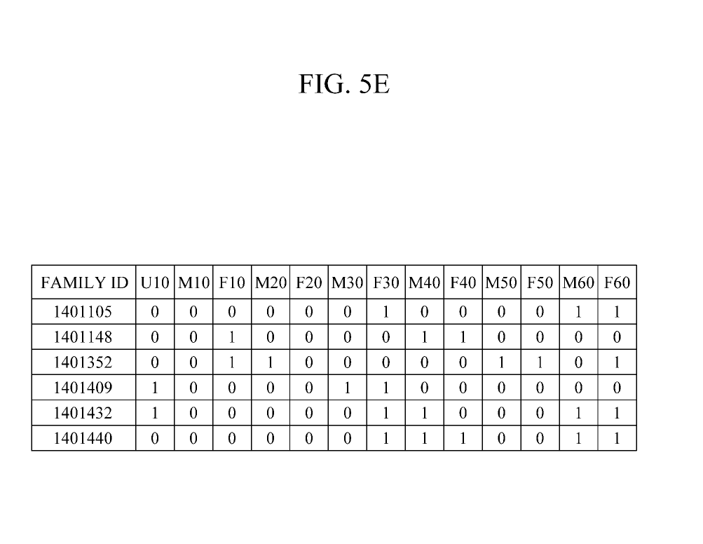

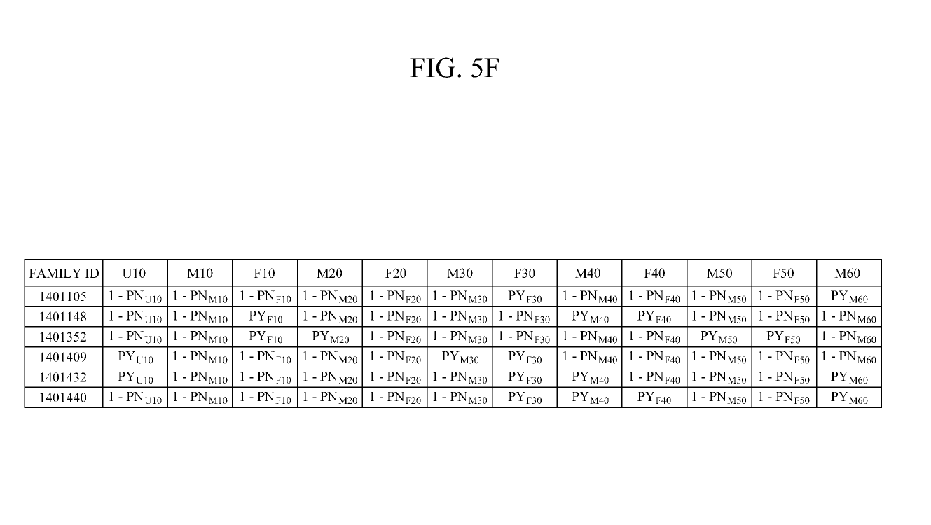

FIGS. 5A to 5F are diagram to explain a method of inferring a user profile by a user inference apparatus to infer an individual audience according to an exemplary embodiment.

FIG. 5A is a flowchart illustrating a process of the audience inference apparatus to infer an individual audience according to an exemplary embodiment.

FIG. 5B is a diagram illustrating an example of a table 510 of the viewership probability distribution of each group by time and day (hereinafter, it will be referred to as a “group/day/time viewership probability distribution table 510”), FIG. 5C is a diagram illustrating an example of a table 520 of the viewership probability distributions of each type of programs being watched by each group (hereinafter, it will be referred to as a “program-type/group viewership probability distribution table 520”), and FIG. 5D is a diagram illustrating an example of tables 530 of the viewership probability distribution of each group by type of program, time and day (hereinafter, it will be referred to as a “time/day/program-type viewership probability distribution table 530”).

FIG. 5E is a diagram illustrating an example of a table showing a result of a primary inference of members of a target family, and FIG. 5F is a diagram illustrating an example of a table showing likelihoods of the presence of family member in accordance with the example of FIG. 5E.

Referring to FIGS. 5A to 5F, the audience inference apparatus infers an individual audience who may be present in the target family that sends a request for viewing TV, based on the primary inference result and a secondary inference result.

The group/day/time viewership probability distribution table 510, the program-type/group viewership probability distribution table 520, and the program-type/group/time/day viewership probability distribution table 530 are based on thirteen groups of people, eight 3-hour time intervals, and seven days, wherein the 13 groups include a group of people under 10s (U10), a group of teenage boys (M10), a group of teenage girls (F10), a group of men in their 50s (M50), a group of women in their 50s (F50), a group of men over 60s (M60), a group of women over 60s (F60), and the like.

In 501, the profile inference component 130 infers an audience member by taking into consideration the primary inference result obtained through the procedures shown in FIG. 2, and FIGS. 3A to 3C, and the secondary inference result obtained through the procedures shown in FIG. 4. In a primary inference result table with respect to members of the target family, the probability of presence of each group belonging to the target family, which is contained in family member information obtained from the primary inference result, reflects the precision of inference of each group. The precision refers to a probability of the inference being correct. If the precision of a group inferred as belonging to the target family is PYₐ and the precision of a group inferred as not being included in the target family is PNₐ, the probability of the presence of the group inferred as being included in the target family is PYₐ and the probability of the presence of the group inferred as not being included in the target family is (1−PNₐ). The profile inference component 130 infers that the age range and gender group with the largest conditional probability is the current audience wherein the conditional probability is obtained from the product of the probability of the presence of a family member and the viewership probability distribution.

The profile inference component 130 may infer the audience based on the primary inference result that infers the group which is present in the target family, and also infer the audience based on family member information of the target family. When using the member information of the target family, the probability of the presence of a group belonging to the target family is 1, and the probability of the presence of a group not belonging to the target family is 0. When receiving the actual family member information of the target family, instead of the primary inference result, the profile inference component 130 infers that a group with the largest probability distribution value relative to TV viewing is the current audience. Depending on whether the table is mapped with the type of program, viewership probability distributions by time and day, or viewership probability distributions by time and day and type of program is used. If there is program type information, the viewership probability distributions by time and day, and type of program may be used. In the same manner, the profile inference component 130 infers that the age group and gender group with the largest conditional probability value is the current audience wherein the conditional probability value is obtained from the product of the probability of the presence of each family member and the viewership probability distribution.

In response to inferring the current audience belonging to the target family based on the primary inference and the secondary inference, the audience inference profile of the target family is generated in 502.

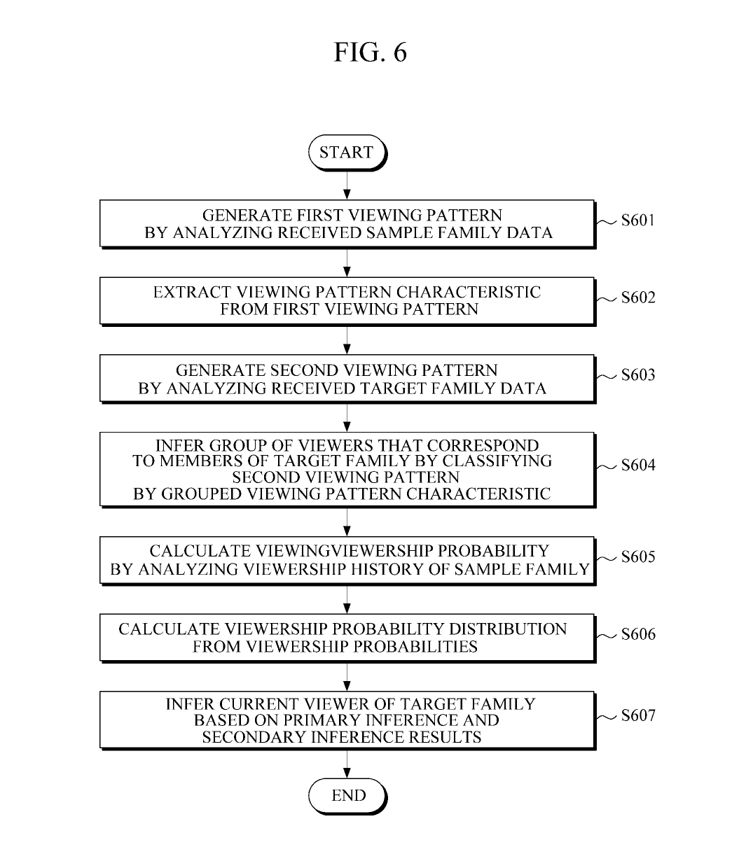

FIG. 6 is a flowchart illustrating a method of inferring a user profile according to an exemplary embodiment.

Referring to FIG. 6, in the method of inferring an audience profile, a first viewing pattern is generated by analyzing received sample family data in S601. The sample family data includes viewership history and profiles of the sample families. The sample families are audience families whose compositions and member profiles including the age range and genders of each member are known, and they are generally registered in advance for the audience rating measurement. The received sample family data contains information about the viewership history corresponding to the profile of the entire family and viewership history corresponding to the profiles of individual members of the sample families. The viewership history of the sample families are divided by individual audiences, and thus it is possible to analyze the history into viewing patterns of each gender, each age group, and each given group. On the contrary, in the case of target families, it is not possible to identify the gender/age range distribution of members, and the viewership histories of audiences are mixed together. Thus, the analysis of the viewing patterns of the individual audience member is not possible, but it is only possible to analyze the viewing patterns of each family.

In S602, viewing pattern characteristics of audiences of each gender/age range group are extracted from the viewing patterns of each family amongst the sample families based on a first viewing pattern generated from the received sample family data. In general, audiences of the same gender/age range group are more likely to exhibit similar viewing patterns. The viewing pattern characteristics of audiences of a specific gender/age range group are extracted by comparing the viewing patterns of families that include the corresponding audiences of the specific gender/age range with the viewing patterns of families that do not include the pertinent audiences. To this end, the viewing patterns of the sample families are categorized by age range and gender and the sample families are divided into two groups of families: one group of families that include members of the specific age range and gender; and the other group of families that do not include members of the specific age range and gender. As many sorters are generated as the number of the age range and gender groups of viewers to be sorted. For example, if the total of 200 sample families consists of 50 families, each including at least one man in his 20s, and the other 150 families that do not include any men in their 20s, a group of male viewers aged 20 to 29 is divided by 50 to 150, and if the 200 sample families consist of 30 families, each including at least one woman in her 20s, and the rest of 170 families, a group of female viewers aged 20 to 29 is divided by 30 to 170. As such, with respect to N specific age range and gender groups of viewers who are to be sorted, the sample family data processor 110 (refer to FIG. 1) generates 2N data groups by dividing the sample families into two groups associated with each of the N specific age range and gender groups of viewers, wherein one family group includes at least one audience member of the corresponding specific age range and gender group; and the other group includes no of the specific age range and gender group. In addition, the sample family data processor 110 extracts the viewing pattern characteristics of each data group from the viewing patterns of the 2N data groups divided by gender/age. Sorter studying is carried out with respect to families with “men in their 20s” and the other families that include no “men in their 20s,” so that a sorter for determining the presence of men in their 20s in a target family can be created. Individual sorters are also generated for the other viewers of different gender/age ranges. As many sorters are generated as the number N of the gender/age range groups of viewers to be sorted. Then, in S603, a second viewing pattern is generated by analyzing received target family data. The target family data is gathered (received) from the target families for inferring the distribution of genders and age ranges of viewers. Unlike the sample family data that includes gender/age profiles of each family member of the sample families, allowing for identification of individual family members' gender and age, the target family data do not include the number of family members and the age range and gender of each family member. In addition, the viewership history of the members of each target family is combined all together, so that it is not possible to analyze the viewing patterns of each viewer. Therefore, the viewing patterns of each target family in general are analyzed based on the viewership history.

In response to the second viewing pattern being generated, the target families' viewing pattern information is categorized using sample families' viewing pattern characteristics information classified by gender/age range, and a group of people corresponding to members of each target family is inferred in S604. The outcome obtained using the viewing pattern characteristics information as the sorters indicates the absence or presence of the characteristic viewing patterns of specific gender/age range audiences. That is, the process of classifying the target families' viewing pattern information based on the sample families' viewing pattern characteristics information is similar to the concept of filtering. The viewership history of the target families may include viewership history of two or more audience member. It is determined whether the target families' viewing patterns include a characteristic viewing pattern, based on the result of classifying the target families' viewership history information using the sample families' viewership history characteristics, and it is further determined whether each target family has an audience showing the characteristic viewing pattern. To infer profiles, for example, gender/age range, of each member of the target families from the target families' viewership history, the viewing patterns of the target families are compared with each gender/age range sorter (sample families' viewing pattern characteristics information) in a parallel fashion. That is, the target families' viewership history information is classified using the sample families' viewership history characteristics information, and the gender/age-associated characteristics of viewership history included in the sample families' viewership history characteristics information are analyzed, and thereby the members of each gender/age range can be inferred from the target families' viewership history information. Operation S604 is equivalent to the primary inference process described with reference to FIGS. 3A to 3C. In response to a primary inference result being obtained, a viewership probability is calculated by analyzing the viewership history of the sample families in S605. Because the sample families' viewership history contained in the sample family data include information about the gender and age range of each member of each sample family, the viewership probability by time and day for each age range and gender group and the viewership probability of a type of program for each age range and gender group can be obtained from the analysis result of the viewership history of the sample families. In the secondary inference process, the viewership history of the sample families whose member profiles including the gender/age range of each member are known are analyzed to calculate the probability of viewing TV. The sample families' viewership history contained in the sample family data includes information about the gender/age range of each member of each sample family. Therefore, from the analysis result of the viewership history of the sample families, it is possible to calculate both the viewership probability by time and day for each age range and gender group of viewers and the viewership probability of a type of program for each age range and gender group. In the secondary inference process, the viewership history of the sample families whose member profiles including the gender/age range of each member are known are analyzed to calculate the viewership probability. The sample families' viewership history contained in the sample family data includes information about the gender/age range of each member of each sample family. Thus, it is possible to calculate, from the analysis result of the sample families' viewership history, both the viewership probability by time and day for each age range and gender group of viewers and the viewership probability of each type of program for each age range and gender group.

In S606, the calculated probabilities are re-calculated into probability distributions for individual groups. For example, the viewership probabilities by time and day, and type of program may be represented as conditional probabilities of the viewership probability distribution by time and day and the viewership probability distribution by type of program. In addition, in response to a request for viewing a specific type of program in specific time interval on a specific day of week being received from a target family member, a probability distribution of each age range and gender group of viewers viewing the specific type of program in the specific time interval on the specific day of week is obtained as a secondary inference result by calculating conditional probabilities for individual gender/age range groups of viewers from a probability distribution of viewing TV in the specific time interval on the specific day of week and a probability distribution of viewing the specific type of program in S607. The obtained secondary inference result may be represented as viewership probability distribution of the individual gender/age range group of viewers.

Then, based on the primary inference result and the secondary inference result, an audience of the target family is inferred in S607. The audience may be inferred by taking into consideration the secondary inference result generated through operation S605. In the primary inference result table with respect to members of the target family, the probability of presence of each group belong to the target family, which is contained in family member information obtained from the primary inference result, reflects the precision of inference of each group. The precision refers to a likelihood of the inference being correct. If the precision of a group inferred as being included in the target family is PYₐ and the precision of a group inferred as not being included in the target family is PNₐ, the probability of the presence of the group inferred as being included in the target family is PYₐ and the probability of the presence of the group inferred as not being included in the target family is (1−PNₐ). The profile inference component 130 infers that the gender/age group with the largest conditional probability is the current audience wherein the conditional probability is obtained from the product of the probability of the presence of a family member and the probability distribution of TV viewing.

In S607, the current audience may be inferred using the primary inference result with respect to a group belonging to the target family, or may be inferred using actual family member information of the target family without using the primary inference result. In the case of using the family member information of the target family, the probability of the presence of the group belonging to the target family is 1 and the probability of the presence of the group not belonging to the target family is 0. In a case where the actual family member information of the target family is input, instead of the primary inference result, a group with the largest probability distribution value relative to TV viewing is inferred as current audiences. Depending on whether the table is mapped with type of program, viewership probability distribution by time and day or viewership probability distribution by time of day, day of week and type of program is used, and if information of type of program is present, viewership probability distribution by time and day, and type of program may be used.

According to the apparatus and method for inferring an audience profile in accordance with the exemplary embodiments of the present disclosure, it is possible to infer audience profiles, such as age range and gender of an audience member from viewership history of the family. Also, by using both viewership probability distribution of each gender/age range group of viewers and inference result of a member of a target family, it is possible to improve the precision of inference of the age range and gender of a current audience, when compared with the inference of the profile of the current audience only using viewership probability distribution. Further, without having to collect family member information of all audience families, the family member information and current audiences can be inferred from viewership history, and the inferred family member information and current audience information may be utilized for targeted advertising.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for a user profile, comprising:
a data processor configured to analyze viewing patterns of sample families from received sample family data, extract viewing pattern characteristics from the analyzed viewing patterns, and generate one or more sorters by classifying the viewing pattern characteristics into groups;
a target family data processor configured to generate target family viewing pattern information based on received target family data; and
a profile inference component configured to generate a primary inference result by classifying the target family viewing pattern information through the one or more sorters and inferring a specific group of members present in the target family based on the viewing pattern characteristics.

2. The apparatus of claim 1, wherein:
the sample family data processor is configured to calculate one or more probabilities related to TV viewing by analyzing viewership history contained in the received sample family data, and
the profile inference component is configured to calculate viewership probability distributions of individual groups of viewers from the one or more calculated probabilities related to TV viewing, and, in response to receiving a request for TV viewing from a viewer that is a member of the target family, generate a secondary inference result by calculating conditional probabilities for individual groups of viewers from a probability distribution of viewing TV in a specific time interval on a specific day of week corresponding to the received request and a probability distribution of viewing a specific type of program corresponding to the received request.

3. The apparatus of claim 2, wherein the profile inference component is configured to infer, based on a likelihood of presence of family member according to the primary inference result and viewership probability distributions according to the secondary inference result, that a group with a largest conditional probability value is an audience member group of the target family.

4. The apparatus of claim 2, wherein the profile inference component is configured to, in a case where family member profiles of the target family are known, infer, based on a likelihood of presence of the family member profiles of the target family and the viewership probability distributions according to the secondary inference result, that a group of viewers with a largest conditional probability value is an audience member group of the target family.

5. The apparatus of claim 2, wherein the sample family data processor is configured to calculate at least one of viewership probabilities according to an amount of TV viewing by type of program, an amount of TV viewing by time of day or an amount of TV viewing by time of day and type of program, a viewership distribution by type of program, a viewership distribution by time of day, or a viewership distribution by time of day and type of program.

6. The apparatus of claim 1, wherein the sample family data processor is configured to generate the one or more sorters by classifying the viewing pattern characteristics into groups according to at least one of gender of viewers, age range of viewers, or type of program.

7. The apparatus of claim 1, wherein the sample family data processor is configured to analyze the sample family data that contains the viewership history and profiles of sample families.

8. The apparatus of claim 1, wherein the target family data processor is configured to generate the target family viewing pattern information from target family data that only contains viewership history of the target family.

9. The apparatus of claim 1, wherein the profile inference component is configured to generate the primary inference result by inferring a specific group of viewers present in the target family by classifying the target family viewing pattern information using sorters that correspond to viewing patterns that are not duplicated among the viewing patterns, which have been classified into the groups for generating the sorters.

10. A method of inferring a user profile, comprising:
analyzing viewing patterns of sample families from received sample family data;
extracting viewing pattern characteristics from the analyzed viewing patterns and generating one or more sorters by classifying the viewing pattern characteristics into groups;
generating target family viewing pattern information from received target family data; and
generating a primary inference result by classifying the target family viewing pattern information through the sorters and inferring a specific group of members present in the target family.

11. The method of claim 10, further comprising:
calculating one or more viewership probabilities by analyzing viewership history contained in the received sample family data;
calculating viewership probability distributions for individual groups of viewers from the one or more viewership probabilities; and
in response to receiving a request for TV viewing from a viewer that is a member of a target family, generating a secondary inference result by calculating conditional probabilities for individual groups of viewers from a probability distribution of viewing TV in a specific time interval on a specific day of week corresponding to the received request and a probability distribution of viewing a specific type of program corresponding to the received request.

12. The method of claim 11, further comprising:
inferring, based on a likelihood of presence of family member according to the primary inference result and viewership probability distributions according to the secondary inference result, that a group of viewers with a largest conditional probability value is an audience member group of the target family.

13. The method of claim 11, further comprising:
in a case where family member profiles of the target family are known, inferring, based on a likelihood of presence of the family member profiles of the target family and the viewership probability distributions according to the secondary inference result, that a group of viewers with a largest conditional probability value is an audience member group of the target family.

14. The method of claim 11, wherein the calculating of the viewership probability distributions from the one or more viewership probabilities comprises calculating at least one of viewership probabilities according to an amount of TV viewing by type of program, an amount of TV viewing by time of day or an amount of TV viewing by time of day and type of program, a viewership distribution by type of program, a viewership distribution by time of day, or a viewership distribution by time of day and type of program.

15. The method of claim 10, wherein the generating of the one or more sorters comprises generating the one or more sorters by classifying the viewing pattern characteristics into groups according to at least one of gender of viewers, age range of viewers, or type of program.

16. The method of claim 10, wherein the analyzing of the viewing patterns of sample families comprises analyzing the sample family data that contains the viewership history and profiles of sample families.

17. The method of claim 10, wherein the generating of the target family viewing pattern information from the received target family data comprises generating the target family viewing pattern information from target family data that only contains viewership history of the target family.

18. The method of claim 10, wherein the generating of the primary inference result comprises generating the primary inference result by inferring a specific group of viewers present in the target family by classifying the target family viewing pattern information using sorters that correspond to viewing patterns that are not duplicated among the viewing patterns which have been classified into the groups for generating the sorters.
